(19) United States
(12) Patent Application Publication
(10) Pub. No.: US 2026/0291025 A1
(43) Pub. Date: Sep. 24, 2026

(54) CURRENT COLLECTING PLATE AND BATTERY CELL INCLUDING THE SAME

(71) Applicant: SK On Co., Ltd., Seoul (KR)

(72) Inventors: Mi So RHO, Daejeon (KR); Min Seong KIM, Daejeon (KR); Yong Seok LEE, Daejeon (KR)

(21) Appl. No.: 19/570,197

(22) Filed: Mar. 18, 2026

(30) Foreign Application Priority Data
Mar. 20, 2025 (KR) 10-2025-0036001

(51) Int. Cl. H01M 50/533; H01M 10/0525; H01M 50/107; H01M 50/152; H01M 50/536; H01M 50/627

(52) U.S. Cl. CPC H01M 50/533; H01M 10/0525; H01M 50/107; H01M 50/152; H01M 50/536; H01M 50/627

(57) ABSTRACT

A current collecting plate is disclosed. In some implementations, the current collecting plate includes: a main body portion electrically connected to an electrode assembly, and having a plate shape; a through-hole formed in a central area of the main body portion; and an electrolyte guide portion formed in at least a portion of a periphery of the through-hole to guide a flow of an electrolyte, wherein the electrolyte guide portion includes an electrolyte drain port through which the electrolyte is drained, a first section forming a downward slope to allow the electrolyte to flow from the through-hole toward the electrolyte drain port, and a second section preventing the electrolyte from flowing toward an outer side of the main body portion, and the electrolyte drain port is formed at an end of the second section.

### CROSS-REFERENCE TO RELATED APPLICATION(S)

This patent document claims the priority and benefits of Korean Patent Application No. 10-2025-0036001 filed on Mar. 20, 2025, the disclosure of which is incorporated herein by reference in its entirety.

### TECHNICAL FIELD

The disclosure and implementations disclosed in this patent document generally relate to a current collecting plate including an electrolyte guide portion, and a battery cell (secondary battery) including the same.

### BACKGROUND

Unlike primary batteries, secondary batteries can be charged with and discharged of electricity, and are used as power sources of devices within various fields such as digital cameras, mobile devices, electric vehicles, and energy storage systems (ESSs). Such secondary batteries come in various types, including lithium secondary batteries, nickel-cadmium batteries, and nickel-metal hydride batteries, and can be manufactured as flexible pouch-type battery cells or rigid can-type battery cells. The can-type battery cells are classified, according to their external shapes, into prismatic battery cells, cylindrical battery cells, coin-type battery cells, and the like, each of which can be applied diversely according to the device and environment in which it is used.

A secondary battery, such as a lithium-ion battery, may include a cathode plate, an anode plate, a separator, an electrolyte, etc. The cathode plate and the anode plate are disposed with the separator made of an insulating material interposed therebetween, while ions are allowed to move through the electrolyte so that the secondary battery can be charged or discharged.

A plurality of battery cells may be stacked to form a cell assembly. The cell assembly may be disposed in a module housing to form a battery module, and a plurality of battery modules may be arranged in a pack frame to form a battery pack.

### SUMMARY

An electrolyte may be injected into a battery cell to cause an electrochemical reaction. However, if a large amount of electrolyte is injected or the electrolyte injection rate is high, the electrolyte may not flow inside an electrode assembly, and may flow back toward an electrolyte injection port.

If the electrolyte injection rate is reduced to prevent backflow of the electrolyte, the process speed may decrease.

The present disclosure can be implemented in some embodiments to provide a current collecting plate capable of reintroducing an electrolyte flowing back toward an electrolyte injection port to an electrode assembly, and a battery cell including the same.

The present disclosure can be implemented in some embodiments to provide a battery cell capable of rapidly injecting an electrolyte.

The present disclosure can be implemented in some embodiments to provide a current collecting plate capable of preventing an electrolyte from flowing out of a battery cell, and a battery cell including the same.

The current collecting plate and the battery cell including the same according to the present disclosure can be widely applied in green technology fields such as electric vehicles, battery charging stations, and renewable energy sources like solar power and wind power. Furthermore, the current collecting plate and the battery cell including the same according to the present disclosure can be used in eco-friendly electric vehicles, hybrid vehicles, and the like to suppress air pollution and greenhouse gas emissions and thereby prevent climate change.

In some embodiments of the present disclosure, a current collecting plate includes: a main body portion electrically connected to an electrode assembly, and having a plate shape; a through-hole formed in a central area of the main body portion; and an electrolyte guide portion formed in at least a portion of a periphery of the through-hole to guide a flow of an electrolyte, wherein the electrolyte guide portion may include an electrolyte drain port through which the electrolyte is drained, a first section forming a downward slope to allow the electrolyte to flow from the through-hole toward the electrolyte drain port, and a second section preventing the electrolyte from flowing toward an outer side of the main body portion, and the electrolyte drain port may be formed at an end of the second section.

In some embodiments of the present disclosure, the second section may form a downward slope from the outer side of the main body portion toward the electrolyte drain port.

In some embodiments of the present disclosure, the second section may vertically connect the outer side of the main body portion and the electrolyte drain port.

In some embodiments of the present disclosure, the first section may be formed to be spaced apart from the through-hole.

In some embodiments of the present disclosure, the main body portion may have a circular plate shape.

In some embodiments of the present disclosure, the electrolyte drain port may have a quadrangular shape.

In some embodiments of the present disclosure, the electrolyte drain port may be formed in a portion of an area corresponding to 60% to 90% of a total radius from the center of the through-hole to the outer side of the main body portion.

In some embodiments of the present disclosure, at least a portion of the second section may cover a portion of the first section, and the first section may further include an electrolyte drain path covered by the second section.

In some embodiments of the present disclosure, a plurality of electrolyte guide portions may be arranged in the current collecting plate, the plurality of electrolyte guide portions being spaced apart from each other along a circumferential direction of the main body portion.

In some embodiments of the present disclosure, a battery cell includes: a cell case including a side portion, a first cap portion disposed on one side of the side portion, a second cap portion disposed on the other side of the side portion, and an electrode terminal disposed in at least one of the first cap portion and the second cap portion; an electrode assembly accommodated in the cell case, the electrode assembly including a cathode plate, an anode plate, and a separator; and a current collecting plate electrically connected to the electrode assembly, wherein the cell case may include an electrolyte injection port for injecting an electrolyte, the current collecting plate may be disposed to face the electrolyte injection port, the current collecting plate may include a main body portion having a plate shape, a through-hole formed in a central area of the main body portion, and an electrolyte guide portion formed in at least a portion of a periphery of the through-hole to guide a flow of the electrolyte, the electrolyte guide portion may include an electrolyte drain port through which the electrolyte is drained, a first section forming a downward slope to allow the electrolyte to flow from the through-hole toward the electrolyte drain port, and a second section preventing the electrolyte from flowing toward an outer side of the main body portion, and the electrolyte drain port may be formed at an end of the second section.

In some embodiments of the present disclosure, the electrolyte injection port may be formed in at least one of the first cap portion, the second cap portion, and the electrode terminal.

In some embodiments of the present disclosure, the side portion may be integrally formed with the first cap portion or the second cap portion.

In some embodiments of the present disclosure, the battery cell may further include: a welding portion where the current collecting plate and the electrode assembly are welded.

In some embodiments of the present disclosure, the welding portion may include a first welding portion disposed in a flat surface area of the main body portion of the current collecting plate.

In some embodiments of the present disclosure, the welding portion may further include a second welding portion disposed between the through-hole and the electrolyte drain port, and the second welding portion may include a circular trajectory located in an area adjacent to the through-hole.

According to some embodiments of the present disclosure, it is possible to reintroduce the electrolyte flowing back toward the electrolyte injection port to the electrode assembly.

According to some embodiments of the present disclosure, it is possible to increase the speed of the electrolyte injection process.

According to some embodiments of the present disclosure, it is possible to prevent the electrolyte from leaking out of the battery cell.

### BRIEF DESCRIPTION OF DRAWINGS

Certain aspects, features, and advantages of the present disclosure are illustrated by the following detailed description with reference to the accompanying drawings.

FIG. 1 is an exploded perspective view of a battery cell according to some embodiments.

FIG. 2 is a cross-sectional view of the battery cell illustrated in FIG. 1.

FIG. 3 is a perspective view of a current collecting plate according to a first embodiment illustrated in FIG. 1.

FIG. 4 is a cross-sectional view taken along line I-I′ of FIG. 3.

FIG. 5 is a plan view illustrating an upper side of the current collecting plate illustrated in FIG. 3.

FIG. 6 is a cross-sectional view of a current collecting plate according to a second embodiment.

FIG. 7 is a cross-sectional view of a current collecting plate according to a third embodiment.

FIG. 8 is a cross-sectional view of a current collecting plate according to a fourth embodiment.

FIG. 9 is a cross-sectional view of a battery cell according to other embodiments.

FIG. 10 is a cross-sectional view of a battery cell according to still other embodiments.

### DETAILED DESCRIPTION

Features of the present disclosure disclosed in this patent document are described by example embodiments with reference to the accompanying drawings.

The present disclosure can be implemented in some embodiments to provide a current collecting plate and a battery cell including the same.

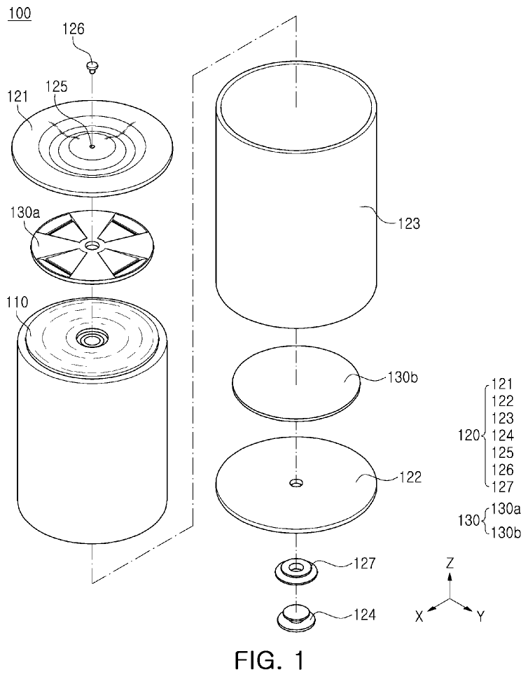

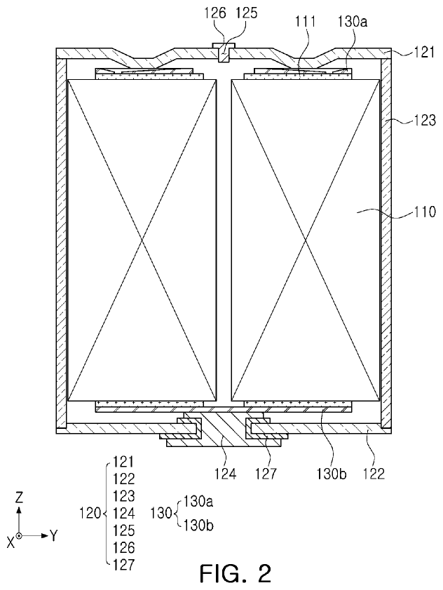

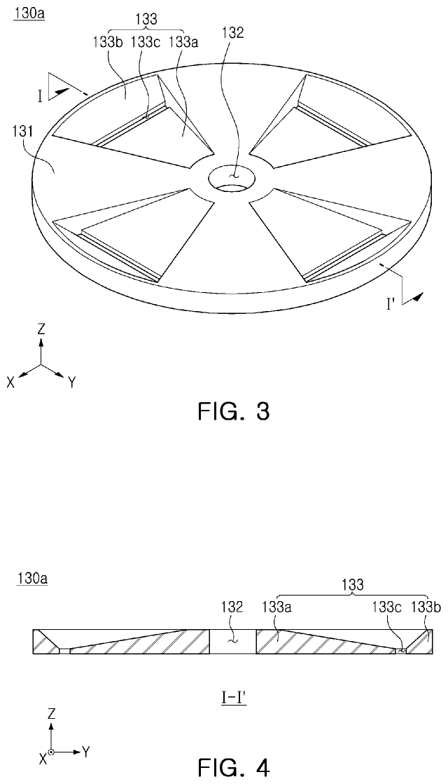

First, a battery cell 100 according to some embodiments of the present disclosure will be described with reference to FIGS. 1 and 2, and a current collecting plate 130a according to a first embodiment of the present disclosure will be described with reference to FIGS. 3 to 5.

FIG. 1 is an exploded perspective view of the battery cell 100 according to some embodiments, and FIG. 2 is a cross-sectional view of the battery cell 100 illustrated in FIG. 1.

Referring to FIGS. 1 and 2, the battery cell 100 according to some embodiments of the present disclosure may include a cell case 120, an electrode assembly 110, and a current collector 130.

The battery cell 100 of the present disclosure may be formed of a secondary battery that can be charged and discharged. The battery cell 100 may have a form in which the electrode assembly 110 and an electrolyte are accommodated inside the cell case 120. As an example, the battery cell 100 may be formed of a lithium-ion (Li-ion) battery or a nickel-metal hydride (Ni-MH) battery, but the type thereof is not limited thereto.

The present disclosure exemplifies a cylindrical cell as the battery cell 100, but may also be applied to another type of battery cell 100, such as a prismatic cell.

The battery cell 100 according to some embodiments of the present disclosure may include a cell case 120 including a side portion 123, a first cap portion 121 disposed on one side of the side portion 123, a second cap portion 122 disposed on the other side of the side portion 123, and an electrode terminal 124 disposed on at least one of the first cap portion 121 and the second cap portion 122, and a current collecting plate 130a electrically connected to the electrode assembly 110 including a cathode plate, an anode plate, and a separator and accommodated inside the cell case 120.

The electrode assembly 110 may include a cathode plate, an anode plate, and a separator. The separator may be interposed between the cathode plate and the anode plate to electrically insulate the cathode plate and the anode plate from each other. The electrode assembly 110 may have various forms, such as a winding type, a stacking type, a zigzag-folding type, and a stack-folding type.

The cathode plate and the anode plate may have a structure in which an active material is applied to a metal foil. Each of the cathode plate and the anode plate may include an uncoated portion on which the active material is not applied. An electrode tab 111 may include an uncoated portion on which the active material is not applied. The cathode plate may include a cathode tab, and the anode plate may include an anode tab.

The current collector 130 may be electrically connected to the electrode assembly 110. The current collector 130 may be electrically connected to the electrode tab 111. As an example, the electrode tab 111 and the current collector 130 may be coupled to each other by welding, such as ultrasonic welding or laser welding, but the coupling method is not limited thereto.

The current collector 130 may include a current collecting plate 130a disposed to face an electrolyte injection port on one side of the electrode assembly 110, and an additional current collector 130b disposed on the other side of the electrode assembly 110. The additional current collector 130b may be omitted.

The current collecting plate 130a may be electrically connected to the electrode assembly 110 on one side of the electrode assembly 110. The current collecting plate 130a may be electrically connected to an electrode tab 111 having a first polarity. As an example, the electrode tab 111 having the first polarity and the current collecting plate 130a may be coupled to each other by welding, such as ultrasonic welding or laser welding, but the coupling method is not limited thereto.

The additional current collector 130b may be electrically connected to the electrode assembly 110 on the other side of the electrode assembly 110. The additional current collector 130b may be electrically connected to an electrode tab 111 having a second polarity. As an example, the electrode tab 111 having the second polarity and the additional current collector 130b may be coupled to each other by welding, such as ultrasonic welding or laser welding, but the coupling method is not limited thereto.

In some embodiments, the first polarity may operate as a cathode and the second polarity may operate as an anode, or conversely, the first polarity may operate as an anode and the second polarity may operate as a cathode. However, in the present disclosure, for convenience of explanation, it will be described as an example that the first polarity operates as a cathode and the second polarity operates as an anode.

The cell case 120 may include a side portion 123, a first cap portion 121, and a second cap portion 122. In a case in which the side portion 123 has a structure in which it is separate from the first cap portion 121 and the second cap portion 122, the side portion 123 may have a form in which both upper and lower portions thereof are open. Alternatively, the side portion 123 may have a form in which either the upper or lower portion thereof is open. The electrode assembly 110 may be inserted into the cell case 120 through the open upper or lower portion.

The side portion 123 may have various shapes. For example, in a case in which the battery cell 100 has a cylindrical shape, the side portion 123 may have a circular tube shape. Referring to FIG. 1, in the present disclosure, the side portion 123 is illustrated, by way of example, as a circular tube with its upper and lower portions being open.

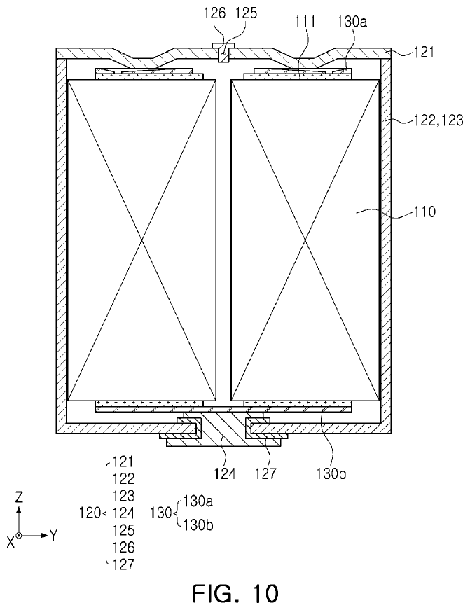

Based on the orientation illustrated in FIGS. 1 and 2, the cell case 120 may include a side portion 123, a first cap portion 121 disposed on the upper side of the side portion 123 and coupled to the side portion 123, and a second cap portion 122 disposed on the lower side of the side portion 123 and coupled to the side portion 123. Conversely, based on the orientation illustrated in the drawings, the cell case 120 may include a side portion 123, and a second cap portion 122 disposed on the upper side of the side portion 123, and a first cap portion 121 disposed on the lower side of the side portion 123. However, the shape or structure of the cell case 120 may be modified in various manner. For example, the side portion 123 can be formed integrally with either the first cap portion 121 or the second cap portion 122 (see FIG. 10).

The first cap portion 121 and the second cap portion 122 may be disposed on one side and the other side of the side portion 123, respectively. The first cap portion 121 and the second cap portion 122 may seal the ends of the side portion 123. Various methods may be applied to seal the open ends of the side portion 123. For example, the second cap portion 122 may be welded to the lower portion of the side portion 123. Various welding methods may be applied for the welding. For example, a laser welding method may be applied. The second cap portion 122 may be welded at an edge while being coupled to the side portion 123.

The cell case 120 may include an electrode terminal 124 disposed in at least one of the first cap portion 121 and the second cap portion 122. The electrode terminal 124 may be electrically connected to the current collector 130, and at least a portion of the electrode terminal 124 may be exposed to the outside of the cell case 120. The electrode terminal 124 may be formed of an electrically conductive material.

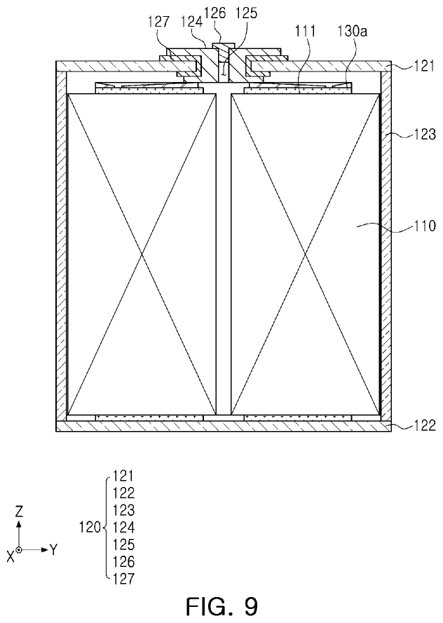

As an example, as illustrated in FIGS. 1 and 2, the electrode terminal 124 may be disposed in the second cap portion 122. The electrode terminal 124 may be disposed in the second cap portion 122 and electrically connected to the additional current collector 130b. For example, at least a portion of the electrode terminal 124 and at least a portion of the additional current collector 130b may be in contact with each other and electrically connected to each other. The electrode terminal 124 may be fitted to the second cap portion 122. The electrode terminal 124 may be riveted to the second cap portion 122. At this time, a gasket 127 may be positioned between the electrode terminal 124 and the second cap portion 122. The electrode terminal 124 and the second cap portion 122 may not be electrically connected to each other by the gasket 127. However, the electrode terminal 124 and the second cap portion 122 may be insulated by an insulating coating or the like, rather than by the gasket 127, and thus, the gasket 127 is not necessarily required. Meanwhile, the electrode terminal 124 may also be disposed in the first cap portion 121, as in an embodiment of FIG. 9 to be described below.

The cell case 120 may include an electrolyte injection port 125 for injecting an electrolyte, and the current collecting plate 130a may be disposed to face the electrolyte injection port 125.

The electrolyte may be injected into the cell case 120 through the electrolyte injection port 125. The electrolyte injection port 125 may be disposed to face the current collecting plate 130a. That is, an upper surface of the current collecting plate 130a may be disposed to face the electrolyte injection port 125. Based on the orientation illustrated in FIG. 2, when the electrolyte injection port 125 is disposed on an upper side of the secondary battery, the current collecting plate 130a may also be disposed on the upper side of the secondary battery. The current collecting plate 130a may be disposed such that, after the electrolyte is injected through the electrolyte injection port 125, the electrolyte flowing back through a through-hole 132 (in FIG. 3) can be reintroduced into the electrode assembly 110. When a large amount of electrolyte is injected through the electrolyte injection port 125, the electrolyte may flow back toward the through-hole 132 (in FIG. 3). The electrolyte having been drained through the through-hole 132 (in FIG. 3) may be reintroduced into the electrode assembly 110 through an electrolyte drain port 133c (in FIG. 3) of the current collecting plate 130a.

The electrolyte injection port 125 may be formed in at least one of the first cap portion 121, the second cap portion 122, and the electrode terminal.

Referring to FIG. 2, the electrolyte injection port 125 may be formed in the first cap portion 121. The electrolyte injection port 125 may be a hole formed by vertically penetrating the first cap portion 121. That is, the first cap portion 121 may have a hole at a central portion thereof, and the hole may serve as the electrolyte injection port 125. Alternatively, the electrolyte injection port 125 may be formed in the second cap portion 122.

A plug 126 may be configured to seal the electrolyte injection port 125. The electrolyte injection port 125 may be open in a state where the current collecting plate 130a and the first cap portion 121 are coupled to each other on the upper side of the cell case 120. An electrolyte may be injected into the case through the electrolyte injection port 125. After the electrolyte is injected, the electrolyte injection port 125 may be sealed by the plug 126.

Hereinafter, the current collecting plate 130a according to the first embodiment of the present disclosure will be described with reference to FIGS. 3 to 5.

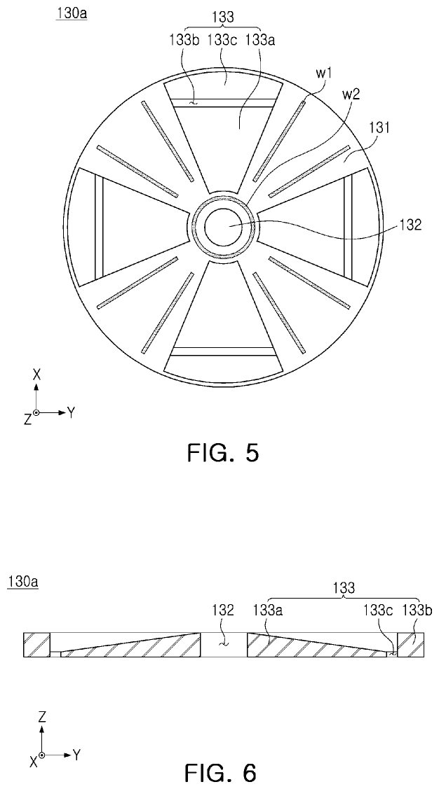

FIG. 3 is a perspective view of the current collecting plate 130a according to the first embodiment, FIG. 4 is a cross-sectional view taken along line I-I′ of FIG. 3, and FIG. 5 is a plan view of the current collecting plate 130a illustrated in FIG. 3.

Referring to FIGS. 3 to 5 together with FIGS. 1 and 2, the current collecting plate 130 a according to the first embodiment of the present disclosure may be electrically connected to the electrode assembly 110, and may include a main body portion 131 having a plate shape, a through-hole 132 formed in a central area of the main body portion 131, and an electrolyte guide portion 133 formed in at least a portion of the periphery of the through-hole 132 and guiding a flow of an electrolyte.

The main body portion 131 may be electrically connected to the electrode assembly 110, and may have a plate shape. The main body portion 131 may have a plate shape corresponding to the size and shape of the electrode assembly 110. For example, the main body portion 131 may have a circular plate shape. In a case in which the battery cell 100 in which the current collecting plate 130a is mounted according to the present disclosure is a cylindrical battery cell 100, the main body portion 131 may have a circular plate shape corresponding thereto.

One flat lower surface of the main body portion 131 may be in contact with an upper portion of the electrode assembly 110. One flat lower surface of the main body portion 131 may be coupled to the electrode assembly 110. For example, one flat lower surface of the main body portion 131 may be welded to the electrode tab 111 of the electrode assembly 110.

The through-hole 132 may be formed in the central area of the main body portion 131. The through-hole 132 may provide a path through which the electrolyte is drained when the electrolyte flows back toward the electrolyte injection port 125 during an electrolyte injection process.

The electrolyte guide portion 133 may include an electrolyte drain port 133c through which the electrolyte is drained, a first section 133a forming a downward slope so that the electrolyte can flow from the through-hole 132 toward the electrolyte drain port 133c, and a second section 133b preventing the electrolyte from flowing in a direction toward an outer side of the main body portion 131, and the electrolyte drain port 133c may be formed at an end of the second section 133b. The electrolyte flowing out through the through-hole 132 may flow along the first section 133a and then move downwardly through the electrolyte drain port 133c to be introduced into the electrode assembly 110.

The first section 133a may form a downward slope to allow the electrolyte to flow from the through-hole 132 to the electrolyte drain port 133c. The first section 133a may serve to guide the electrolyte to flow toward the electrolyte drain port 133c. The first section 133a may be formed to be spaced apart from the through-hole 132. The first section 133a may start at a position spaced apart from the through-hole 132. For example, the first section 133a may start from a middle area of the main body portion 131. A section between the first section 133a and the through-hole 132 may form a flat surface. The formation of the flat surface between the first section 133a and the through-hole 132 may be advantageous in the process of welding the electrode assembly 110 and the current collecting plate 130a, which will be described below.

The first section 133a may be formed in connection with the through-hole 132. The formation of the first section 133a in connection with the through-hole 132 may be advantageous in guiding the electrolyte that is flowing back to the first section. In addition, the formation of the first section 133a in connection with the through-hole 132 may increase the length of the first section 133a.

The second section 133b may serve to prevent the electrolyte from flowing from the first section 133a toward the outer side of the main body portion 131. The second section 133b may serve to prevent the electrolyte from flowing from the electrolyte drain port 133c toward the outer side of the main body portion 131. If the amount of the electrolyte that is flowing back is large or the speed of the electrolyte that is flowing back is high, the electrolyte may pass the electrolyte drain port 133c. In such a case, the second section 133b may prevent the electrolyte from flowing outwardly and guide the electrolyte to be stably discharged through the electrolyte drain port 133c. The second section 133b may prevent the electrolyte flowing along the downward slope of the first section 133a from passing the electrolyte drain port 133c and flowing toward the outer side of the main body portion 131.

The second section 133b may form a downward slope from the outer side of the main body portion 131 toward the electrolyte drain port 133c. The second section 133b may form a downward slope to prevent the electrolyte flowing along the downward slope of the first section 133a from passing the electrolyte drain port 133c and flowing toward the outer side of the main body portion 131. The second section 133b may guide the electrolyte to flow toward the electrolyte drain port 133c. In a case in which the second section 133b forms a downward slope, the electrolyte can be guided more smoothly to the electrolyte drain port 133c.

The electrolyte drain port 133c may be a passage through which the electrolyte discharged from the through-hole 132 is drained toward the electrode assembly 110. The electrolyte drain port 133c may be a hole through which the electrolyte discharged from the through-hole 132 is drained toward the electrode assembly 110. The electrolyte drain port 133c may be formed by penetrating the current collecting plate 130a.

The electrolyte drain port 133c may be formed at an end of the second section 133b. The electrolyte drain port 133c may be formed between the second section 133b and the first section 133a. The second section 133b may refer to a section from the electrolyte drain port 133c to an outer side surface of the main body portion 131.

The electrolyte drain port 133c may be formed in a portion of an area corresponding to 60% to 90% of a total radius from the center of the through-hole 132 to the outer side of the main body portion 131. If the electrolyte drain port 133 c is formed in an area smaller than 60% of the total radius from the center of the through-hole 132 to the outer side of the main body portion 131, the electrolyte may not be properly guided and thus may not be smoothly discharged. Conversely, if the electrolyte drain port 133c is formed in an area larger than 90% of the total radius from the center of the through-hole 132 to the outer side of the main body portion 131, the position of the electrolyte drain port 133c may be too close to the outer side surface of the main body portion 131, and the electrolyte may leak to the outside during a discharge process.

Referring to FIG. 5, the electrolyte drain port 133c may have a quadrangular shape. As an example, the electrolyte drain port 133c may have a rectangular shape or a trapezoidal shape. In a case in which the electrolyte drain port 133c has a quadrangular shape, a larger amount of electrolyte can be efficiently discharged. Furthermore, the electrolyte drain port 133c having a quadrangular shape may be advantageous in the process of forming the electrolyte drain port 133c.

A plurality of electrolyte guide portions 133 may be arranged in the current collecting plate 130a, and the plurality of electrolyte guide portions 133 may be arranged to be spaced apart from each other in a circumferential direction of the main body portion 131.

For example, as illustrated in FIG. 5, four electrolyte guide portions 133 may be arranged in the main body portion 131. However, the number of electrolyte guide portions 133 may be variously modified. At this time, the plurality of electrolyte guide portions 133 may be arranged to be spaced apart from each other along the circumferential direction of the main body portion 131. The plurality of electrolyte guide portions 133 may be arranged to be spaced apart from each other at regular intervals along the circumferential direction of the main body portion 131. The plurality of electrolyte guide portions 133 may allow the electrolyte that has flowed back to be rapidly reintroduced into the electrode assembly 110, thereby increasing efficiency.

Referring to FIG. 5, the current collecting plate 130a may additionally include a welding portion to which the electrode assembly 110 is welded.

The welding portion may be an area for electrically connecting the current collecting plate 130a to the electrode assembly 110. The welding portion may be an area for coupling the current collecting plate 130a to the electrode assembly 110. The welding portion may be an area for welding the electrode tab 111 of the electrode assembly 110 to the current collecting plate 130a.

The welding portion may include a first welding portion w1 located in a flat surface area of the main body portion 131 of the current collecting plate 130a.

The first welding portion w1 may be located in the flat surface area. Specifically, the first welding portion w1 may be located between the electrolyte guide portions 133 adjacent to each other in the circumferential direction of the main body portion 131. The first welding portion w1 may be at least a portion of a flat surface area among areas other than the electrolyte guide portions 133 in the main body portion 131 of the current collecting plate 130a. The first welding portion w1 located in the flat surface area may be advantageous in the welding process as compared to a first welding portion w1 located in an inclined portion.

The welding portion may further include a second welding portion w2 located between the through-hole 132 and the electrolyte drain port 133c, and the second welding portion w2 may include a circular trajectory located in an area adjacent to the through-hole 132.

The second welding portion w2 may be located between the through-hole 132 and the electrolyte drain port 133c. In a case in which the electrolyte guide portion 133 is formed to be spaced apart from the through-hole 132, the second welding portion w2 may be located in a flat surface area. The second welding portion w2 may be a circular trajectory surrounding the through-hole 132. The second welding portion w2 located in the flat surface area may be more advantageous in the welding process.

In a case in which the electrolyte guide portion 133 is formed to be connected to the through-hole 132, the second welding portion w2 may be located in an inclined portion. In a case in which the second welding portion w2 is located in the inclined portion, a smaller step between the flat surface portion and the inclined portion may be more advantageous for welding. For the welding process, the second welding portion w2 may be located in an area as close to the through-hole 132 as possible.

Referring to FIG. 6, a current collecting plate 130a according to a second embodiment will be described.

FIG. 6 is a cross-sectional view of the current collecting plate 130a according to the second embodiment. The description of the main body portion 131, the through-hole 132, the first section 133a, the electrolyte drain port 133c, and the welding portion in the first embodiment may also be applied to the second embodiment.

When compared to the current collecting plate 130a according to the first embodiment of FIG. 4, the current collecting plate 130a according to the second embodiment illustrated in FIG. 6 is different in that the first section 133a is formed to be connected to the through-hole 132, and the second section 133b is formed vertically.

The second section 133b may vertically connect the outer side of the main body portion 131 and the electrolyte drain port 133c. The second section 133b may be formed vertically from the electrolyte drain port 133c to prevent the electrolyte flowing along the first section 133a from passing the electrolyte drain port 133c and flowing toward the outer side of the main body portion 131. The second section 133b may function to block the electrolyte from passing the electrolyte drain port 133c. The second section 133b formed vertically may be advantageous in the process of designing and producing the current collecting plate 130a.

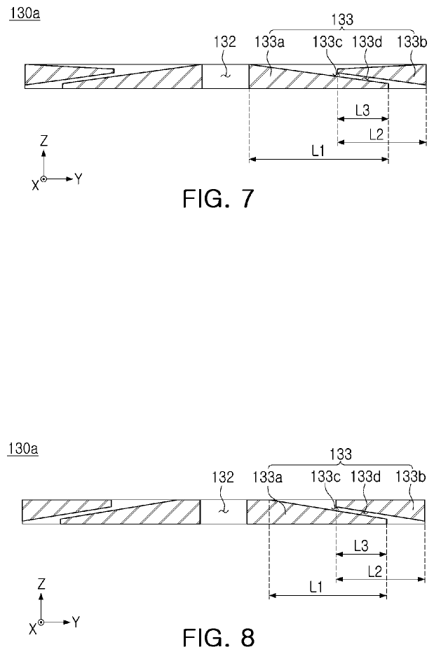

Referring to FIG. 7, a current collecting plate 130a according to a third embodiment will be described.

FIG. 7 is a cross-sectional view of the current collecting plate 130a according to the third embodiment.

When compared to the current collecting plate 130a according to the first embodiment of FIG. 4, FIG. 7 is different in that the second section 133b is formed to cover at least a portion of the first section 133a, and the first section 133a is formed to be connected to the through-hole 132. The description of the main body portion 131, the through-hole 132, the first section 133a, the electrolyte drain port 133c, and the welding portion in the first embodiment may also be applied to the third embodiment.

The current collecting plate 130a according to the third embodiment of the present disclosure may include a main body portion 131, a through-hole 132, and an electrolyte guide portion 133, and the electrolyte guide portion 133 may include an electrolyte drain port 133c, an electrolyte drain path 133d, a first section 133a, and a second section 133b.

At least a portion of the second section 133b may cover a portion of the first section 133a, and the first section 133a may additionally include an electrolyte drain path 133d covered by the second section 133b.

The electrolyte drain port 133c may be formed at an end of the second section 133b. The electrolyte drain path 133d may be an area where the second section 133b covers the first section 133a. The first section 133a may have a length of L1. The second section 133b may have a length of L2. The electrolyte drain path 133d may have a length of L3.

The electrolyte may flow through the electrolyte drain path 133d. The second section 133b may be spaced apart from the first section 133a in a thickness direction of the current collecting plate 130a to allow the electrolyte to flow through the electrolyte drain path 133d. The electrolyte drain path 133d may reduce the backflow of the electrolyte. By covering at least a portion of the first section 133a, the second section 133b may more effectively prevent the electrolyte from flowing to the outer side of the main body portion 131.

The second section may form a downward slope from the outer side of the main body portion 131 toward the electrolyte drain port 133c. The second section 133b may form a downward slope to prevent the electrolyte flowing along the downward slope of the first section 133a from passing the electrolyte drain port 133c and flowing toward the outer side of the main body portion 131. The second section 133b may guide the electrolyte to flow toward the electrolyte drain port 133c and to be drained through the electrolyte drain path 133d.

Referring to FIG. 8, a current collecting plate 130a according to a fourth embodiment will be described. FIG. 8 is a cross-sectional view of the current collecting plate 130a according to the fourth embodiment. The description of the main body portion 131, the through-hole 132, the first section 133a, the electrolyte drain port 133c, and the welding portion in the first embodiment may also be applied to the fourth embodiment.

The description of the electrolyte drain path 133d in the third embodiment may also be applied to the fourth embodiment.

Compared to FIG. 7, the current collecting plate 130a illustrated in FIG. 8 is different in that the first section 133a is formed to be spaced apart from the through-hole 132, and the second section 133b is formed vertically.

The first section 133a may be spaced apart from the through-hole 132, and may start from a middle portion of the main body portion 131. A section between the first section 133a and the through-hole 132 may form a flat surface. The first section 133a may have a length of L1.

The second section 133b may vertically connect the outer side of the main body portion 131 and the electrolyte drain port 133c. The second section 133b may be formed vertically from the electrolyte drain port 133c to prevent the electrolyte flowing along the downward slope of the first section 133a from passing the electrolyte drain port 133c and flowing toward the outer side of the main body portion 131. The second section 133b may function to prevent the electrolyte from passing the electrolyte drain port 133c.

In FIGS. 3 to 8, the current collecting plate 130a is illustrated with a somewhat exaggerated thickness for clarity of illustration, and the size and thickness of the current collecting plate 130a may be variously modified.

Referring to FIGS. 9 and 10, battery cells 100 according to other embodiments of the present disclosure will be described.

FIG. 9 is a cross-sectional view of a battery cell 100 according to other embodiments.

The description of the cell case 120, the electrode assembly 110, and the current collecting plate 130a in some embodiments may also be applied to other embodiments. When compared to the battery cell 100 according to some embodiments of FIG. 2, the battery cell 100 according to other embodiments of FIG. 9 is different in that the electrode terminal is disposed in the first cap portion 121, and the electrolyte injection port 125 is formed in the electrode terminal.

Referring to FIG. 9, the electrode terminal 124 may be disposed in the first cap portion 121. The electrode terminal may be disposed in the first cap portion 121 and electrically connected to the current collecting plate 130a. For example, at least a portion of the electrode terminal and at least a portion of the current collecting plate 130a may be in contact with each other and electrically connected to each other. The electrode terminal may be fitted to the first cap portion 121. The electrode terminal may be riveted to the first cap portion 121. At this time, a gasket 127 may be positioned between the electrode terminal and the first cap portion 121. The electrode terminal and the first cap portion 121 may not be electrically connected to each other by the gasket 127. However, the electrode terminal and the first cap portion 121 may be insulated by an insulating coating or the like, rather than by the gasket 127, and thus, the gasket 127 is not necessarily required.

The electrode terminal 124 may be coupled to the flat surface portion of the current collecting plate 130a. The electrode terminal 124 may be coupled to the welding portion of the current collecting plate 130a. The electrode terminal may be welded to the first welding portion w1 so as not to prevent the electrolyte from flowing along the first section 133a. The first section 133a of the current collecting plate 130a may be formed to be connected to the through-hole 132. The first section 133a may be connected from the through-hole 132, so that the electrolyte that has flowed back can be guided to the electrolyte drain port 133c.

The electrolyte injection port 125 may be formed in the electrode terminal. The electrolyte injection port 125 may be formed to penetrate the electrode terminal. By forming the electrolyte injection port 125 in the electrode terminal, there is no need to install a separate electrolyte injection port 125 in another portion of the secondary battery, thereby simplifying the structure and increasing space efficiency.

The plug 126 may be configured to seal the electrolyte injection port 125 of the electrode terminal. The electrolyte injection port 125 formed in the electrode terminal may be in an open state. An electrolyte may be injected into the case through the electrolyte injection port 125. After the electrolyte is injected, the electrolyte injection port 125 may be sealed by the plug 126. For example, the plug 126 may be fitted into the electrolyte injection port 125 of the electrode terminal.

FIG. 10 is a cross-sectional view of a battery cell 100 according to still other embodiments.

When compared to FIG. 2, the battery cell 100 illustrated in FIG. 10 is different in that the side portion 123 and the second cap portion 122 are formed integrally. The description of the cell case 120, the electrode assembly 110, and the current collecting plate 130a in some embodiments may also be applied to still other embodiments.

The side portion 123 may be formed integrally with the first cap portion 121 or the second cap portion 122.

The side portion 123 may be a structure formed integrally with at least one of the first cap portion 121 or the second cap portion 122. That is, at least one of upper and lower surfaces of the side portion 123 may be formed integrally with the cap portion. A lower portion of the side portion 123 may be formed integrally with the second cap portion 122, or an upper portion of the side portion 123 may be formed integrally with the first cap portion 121.

In a case in which the side portion 123 and the first cap portion 121 or the second cap portion 122 are formed integrally, the process of joining the side portion 123 and the cap portion is not required, making it easy to manufacture the cell case 120 and/or the battery cell 100 and improving workability. In addition, in a case in which the side portion 123 and the first cap portion 121 or the second cap portion 122 are formed integrally, the joining portion may be reduced, which is advantageous in increasing the durability and structural strength of the cell case 120.

Only specific examples of implementations of certain embodiments are described. Variations, improvements and enhancements of the disclosed embodiments and other embodiments may be made based on the disclosure of this patent document.

What is claimed is:

1. A current collecting plate comprising:
a main body portion electrically connected to an electrode assembly, and having a plate shape;
a through-hole formed in a central area of the main body portion; and
an electrolyte guide portion formed in at least a portion of a periphery of the through-hole to guide a flow of an electrolyte,
wherein the electrolyte guide portion includes an electrolyte drain port through which the electrolyte is drained, a first section forming a downward slope to allow the electrolyte to flow from the through-hole toward the electrolyte drain port, and a second section preventing the electrolyte from flowing toward an outer side of the main body portion, and
the electrolyte drain port is formed at an end of the second section.

2. The current collecting plate of claim 1, wherein the second section forms a downward slope from the outer side of the main body portion toward the electrolyte drain port.

3. The current collecting plate of claim 1, wherein the second section vertically connects the outer side of the main body portion and the electrolyte drain port.

4. The current collecting plate of claim 1, wherein the first section is formed to be spaced apart from the through-hole.

5. The current collecting plate of claim 1, wherein the main body portion has a circular plate shape.

6. The current collecting plate of claim 1, wherein the electrolyte drain port includes a quadrangular shape.

7. The current collecting plate of claim 1, wherein the electrolyte drain port is formed in a portion of an area corresponding to 60% to 90% of a total radius from a center of the through-hole to the outer side of the main body portion.

8. The current collecting plate of claim 1, wherein at least a portion of the second section covers a portion of the first section, and
the first section further includes an electrolyte drain path covered by the second section.

9. The current collecting plate of claim 1, wherein a plurality of electrolyte guide portions are arranged in the current collecting plate, the plurality of electrolyte guide portions being spaced apart from each other along a circumferential direction of the main body portion.

10. A battery cell comprising:
a cell case including a side portion, a first cap portion disposed on one side of the side portion, a second cap portion disposed on the other side of the side portion, and an electrode terminal disposed in at least one of the first cap portion and the second cap portion;
an electrode assembly accommodated in the cell case, the electrode assembly including a cathode plate, an anode plate, and a separator; and
a current collecting plate electrically connected to the electrode assembly,
wherein the cell case includes an electrolyte injection port for injecting an electrolyte,
the current collecting plate is disposed to face the electrolyte injection port,
the current collecting plate includes a main body portion having a plate shape, a through-hole formed in a central area of the main body portion, and an electrolyte guide portion formed in at least a portion of a periphery of the through-hole to guide a flow of the electrolyte,
the electrolyte guide portion includes an electrolyte drain port through which the electrolyte is drained, a first section forming a downward slope to allow the electrolyte to flow from the through-hole toward the electrolyte drain port, and a second section preventing the electrolyte from flowing toward an outer side of the main body portion, and
the electrolyte drain port is formed at an end of the second section.

11. The battery cell of claim 10, wherein the electrolyte injection port is formed in at least one of the first cap portion, the second cap portion, and the electrode terminal.

12. The battery cell of claim 11, wherein the side portion is integrally formed with the first cap portion or the second cap portion.

13. The battery cell of claim 10, further comprising:
a welding portion where the current collecting plate and the electrode assembly are welded.

14. The battery cell of claim 13, wherein the welding portion includes a first welding portion disposed in a flat surface area of the main body portion of the current collecting plate.

15. The battery cell of claim 14, wherein the welding portion further includes a second welding portion disposed between the through-hole and the electrolyte drain port, and
the second welding portion includes a circular trajectory located in an area adjacent to the through-hole.
